(19) United States
(12) Patent Application Publication
(10) Pub. No.: US 2025/0391075 A1
(43) Pub. Date: Dec. 25, 2025

(54) SYSTEM AND METHOD FOR GENERATING VIDEO VARIATION BASED ON VIDEO MODEL

(71) Applicant: Idomoo LTD, Raanana (IL)

(72) Inventor: Danny KALISH, Raanana (IL)

(21) Appl. No.: 19/244,214

(22) Filed: Jun. 20, 2025

Related U.S. Application Data
(60) Provisional application No. 63/662,136, filed on Jun. 20, 2024.

(51) Int. Cl. G06T 11/60

(52) U.S. Cl. CPC G06T 11/60

(57) ABSTRACT

The present invention discloses a method for creating variation video; based on the model, the method comprising the steps of:
Generating video model with IDM layer with hints to the AI type of field, with place holder of call to action; intention of the video creator
Embed with video model invitation details in format logic of template for different variations to customization;
The video model includes template general layout, the AI changes the content of the template based on hinting of the templates defined by the human of the template, such as hint what will be in the content type logo, location, wherein language of template, tags what type of content to place

### FIELD OF THE INVENTION

The present invention relates generally to generation video variation. More particularly, the present invention relates to generating variation video files-based video model using AI models.

### BACKGROUND OF THE INVENTION

In the era of personalized content consumption, video production has become increasingly dynamic, enabling customization for diverse audiences, contexts, and platforms. Traditional methods of video creation often rely on static content, leading to limited flexibility and personalization. With the growth of digital media platforms, there is an increasing demand for adaptive video systems that can produce personalized content efficiently and at scale. However, creating such customized video content manually or through traditional editing processes is time-consuming, expensive, and lacks scalability.

### SUMMARY OF THE INVENTION

The present invention discloses a method for creating variation video; based on the model, the method comprising the steps of:
Generating video model with IDM layer with hints to the AI type of field, with place holder of call to action; intention of the video creator
Embed with video model invitation details in format logic of template for different variations to customization;
The video model includes template general layout, the AI changes the content of the template based on hinting of the templates defined by the human of the template, such as hint what will be in the content type logo, location, wherein language of template, tags what type of content to place

The present invention discloses A computer-implemented method for generating a variant building blocks Video files, implemented by one or more processors operatively coupled to a non-transitory computer readable storage device, on which are stored modules of instruction code that when executed cause the one or more processors to perform said method comprising the steps of:
generating, by a video model builder module, at least one building blocks, each building block defines by hints and instructions configured to define:
   functional elements and length;
   object parameters and properties per frame layer, including at least one of: color, position, visibility, shape, and size;
   customization parameters comprising instructions and hints for video variation;
   placeholders for call-to-action elements;
   binary media object data or links to external media resources; and
processing, by an artificial intelligence (AI) engine, the instructions and hints of the building blocks to:
   determine a sequence and selection of building blocks based on user prompt, profile data, contextual information, and environmental conditions;
   update object properties dynamically per frame according to customization rules;
   define inter-object relationships and generate frame layers accordingly;
generating, based on the processed frame layers, at least one customized variant video file or stream.

According to some embodiments of the present invention the AI model fills out form's fields based on the hints and instructions, optionally by accessing a knowledge base or other contextual resources.

According to some embodiments of the present invention a given storyboard defines the scenario, which determines one or more functional elements, including hints for the type of building block objects to be used.

According to some embodiments of the present invention based on the storyboard are defined hints for placeholders of calls to actions.

According to some embodiments of the present invention each building block customization rules are determined by applying AI models based on the hint and instructions.

According to some embodiments of the present invention the generation of the frame layers is according to the binary media object data, including the updated properties for each frame and the customization rules.

The present invention discloses a system for generating variant video content implemented by one or more processors operatively coupled to a non-transitory computer readable storage device, which comprise the module of:
a video model builder configured to create a at least one building blocks, each building block defines by hints and instructions for comprising a plurality of building blocks, object properties, and AI customization hints;
a customization server configured to retrieve contextual data and user profile information;
an AI engine configured to:
   interpret and analyses user prompt, the customization hints;
   determine a sequence and selection of building blocks based on user prompt, profile data, contextual information, and environmental conditions
   assign object properties and scene ordering;
   determine relationships between objects and generate customization rules;
a video generation module configured to assemble video frame layers based on updated properties and generate at least one playable video or stream

According to some embodiments of the present invention the AI model fills out forms or placeholder fields based on the building blocks Video files hints, optionally by accessing a knowledge base or other contextual resources.

According to some embodiments of the present invention a given storyboard defines the scenario, which determines one or more functional elements, including hints for the type of building block objects to be used.

According to some embodiments of the present invention based on the storyboard are defined hints for placeholders of calls to actions.

According to some embodiments of the present invention each building block customization rules are determined by applying AI models based on building blocks Video files hint and instructions.

The present invention discloses a method for creating variation video; based on the video building blocks Video files implemented by one or more processors operatively coupled to a non-transitory computer readable storage device, on which are stored modules of instruction code that when executed cause the one or more processors to perform said method comprising the steps of:
Generating video blocks comprising instructions and hints for creating variations of the building blocks Video files I using an Artificial Intelligence (AI) engine p1 eating changing the content and format/structure of the video blocks by AI model based on hints/instructions of the video blocks based on given video instructions based on given prompt.

### DESCRIPTION OF THE DRAWINGS

The present invention will be more readily understood from the detailed description of embodiments thereof made in conjunction with the accompanying drawings of which:

FIG. 1 is a block diagram showing components and environment of a system for generating variant video from model file, according to some embodiments of the invention;

FIG. 1A is a block diagram showing components and environment of a system for generating variant video from story board model file, according to some embodiments of the invention;

FIG. 2 is a diagram of model video file format, according to some embodiments of the invention;

FIG. 2A is a diagram of model video file based on storyboard, according to some embodiments of the invention;

FIG. 3A is a flowchart diagram of Model Video Builder module, according to some embodiments of the invention;

FIG. 3B is a block diagram storyboard Model Video Builder module, according to some embodiments of the invention;

FIG. 4A is a flowchart diagram showing a process carried out by Ai model for generating variant video based on building block, according to some embodiments of the invention; and

FIG. 4B is a flowchart diagram showing the process carried out by the AI model for generating variant videos based on storyboard, according to some embodiments of the invention.

### DETAILED DESCRIPTION OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The following is a table of definitions of the terms used throughout this application, adjoined by their properties and examples.

| Term | Definition | Properties | Example |
|---|---|---|---|
| Media | Basic building block of | Material properties of | Blue triangle |
| Object | video building block. | objects for each frame for | |
| | | each layer of building | |
| | | blocks, e.g. color, position, | |
| | | visibility, opacity, shape, | |
| | | size etc. | |
| | | Motion properties | |
| | | Special effects properties, | |
| | | e.g.: lighting, shading etc. | |
| | | Each object type may | |
| | | require a different optimal | |
| | | compression rule | |
| | | May be replaced by a | |
| | | “Binary data container”, | |
| | | i.e.: objects or links to | |
| | | objects | |
| Media | Motion parameters: object's | | |
| Object | motion in relation to each | | |
| configuration | video frame layers or group | | |
| parameter | of frames | | |
| | Material parameters: | | |
| | properties of objects for | | |
| | each frame, e.g.: color, | | |
| | position, visibility, shape, | | |
| | size | | |
| | Lighting and special | | |
| | effects, e.g. shading | | |
| Video | Basic block of a displayable | | presenting the |
| block | video sequence with pre- | | username and |
| | defined functionality. | | time of day. |
| | comprised of video frames, | | |
| | each frame comprised of | | |
| | dynamic and static layers | | |
| | Comprised of media objects | | |
| | (see above), this is the basic | | |
| | building block of an | | |
| | encapsulated video file (see | | |
| | below). | | |
| | Media blocs may be | | |
| Video | Comprised of dynamic and | | |
| frame | static layers | | |
| | Each layer comprised of | | |
| | media object | | |
| Building | Environment parameters | Environment building | Environment |
| block | Context parameters | block parameters enable | parameters: |
| configuration | User profile parameters | diversifying the video | show lighting |
| parameters | | presentation according to | according to |
| | | external information | the actual time |
| | | sources: | of day. |
| | | Context building block | Context |
| | | parameters enable | parameters: |
| | | diversifying the video | Personalization |
| | | presentation according to | parameters: |
| | | user profile parameters | “Hello Mr. |
| | | User profile building block | Smith. Here is |
| | | parameters enable | your schedule |
| | | diversifying the video | for today . . . ” |
| | | presentation according to | |
| | | user profile parameters: | |
| | | name, age, gender, | |
| Extension | Parameters that apply | Global lighting, Global | Shine all |
| functionalities | globally to all media | shading, | objects from a |
| | objects that reside | Global motion | specific angle |
| | hierarchically under a | | |
| | specific building block. | | |
| Selection | Video customization | | If user's age is |
| customization | parameters that determine | | below 6 years - |
| parameter | the selection and ordering | | show |
| | of building block | | “Sesame |
| | | | Street” |
| Appearance | Video customization | | If user is a boy - |
| customization | parameters that affect the | | show blue |
| parameters | video appearance, e.g.: | | background, |
| | inserting a name, picture | | otherwise |
| | etc. | | show pink |
| | | | background |
| Video | A service designed to | | |
| customization | provide a mechanism for | | |
| server | dynamically changing | | |
| | customization parameters | | |
| Encoder | A software module, | | |
| | designed to encode | | |
| | encapsulated video file | | |
| | formats. | | |
| Decoder | A software module, | Frontend, UI | |
| | designed to present | | |
| | encoded encapsulated video | | |
| | files. | | |
| | The Decoder can produce | | |
| | video data either as: | | |
| | 1 A video file of other | | |
| | industry acknowledged | | |
| | format (e.g. MPEG4) or | | |
| | 2 A direct video stream | | |

This invention addresses these challenges by introducing a system for generating variant video content from building blocks of video files. The system leverages an Artificial Intelligence (AI)-based model to automate the generation of customized videos from pre-defined video segments or “building blocks.” These building blocks may include individual video scenes, images, audio, and other media elements, each of which can be modified and personalized according to specific user inputs or contextual data. By applying AI-driven models, the invention allows for the seamless integration of external resources and dynamic customization based on user profiles, environmental conditions, and predefined rules.

The system employs a Video Model Builder, which is responsible for constructing video content from building blocks by incorporating customization parameters and hints. These instructions guide the AI engine to adapt video elements such as color, position, size, motion, and even interactive components like calls to action. The AI engine further refines the video content by adjusting these parameters to meet specific user or environmental requirements.

This invention facilitates the creation of videos that are not only personalized but also optimized for diverse distribution formats, such as streaming or as downloadable, playable video files. The generated variant videos can be tailored for specific devices, platforms, or audiences, enhancing engagement and viewer experience.

In addition, the invention enables content creators to easily define and manage customization parameters, functional elements, and video sequencing through a storyboard or model files, simplifying the video creation process and increasing its adaptability. This solution provides an efficient, scalable way to generate videos that maintain high quality while being contextually relevant and engaging for different viewers.

The ability to use AI models to define video parameters, select building blocks, and dynamically adjust content offers substantial advantages over traditional video creation methods, enabling rapid deployment of personalized video content with minimal manual intervention. This invention thus represents a significant advancement in the field of video generation and customization, offering both technical innovation and commercial value to businesses, marketers, and content creators

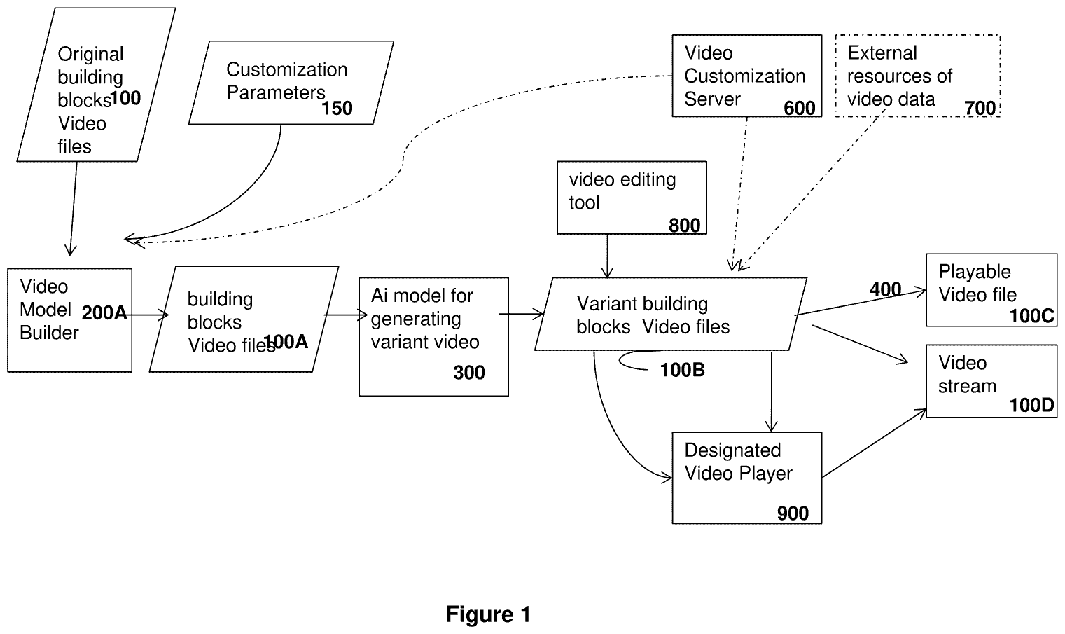

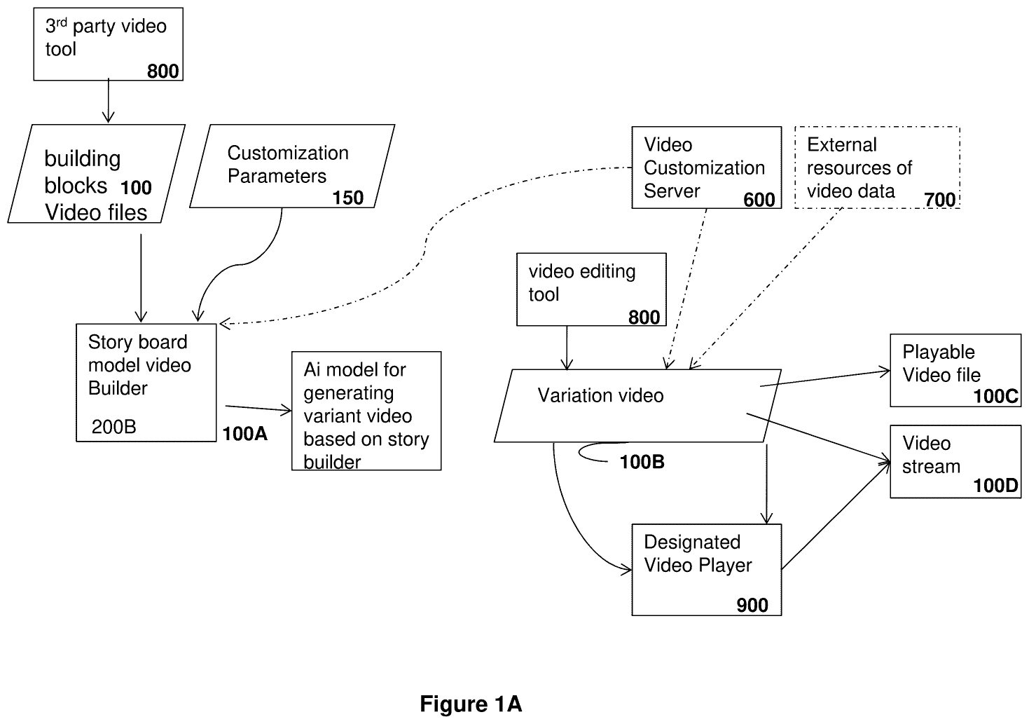

FIG. 1 is a block diagram showing components and environment of a system for generating variant video from model file, according to some embodiments of the invention.

The Video Model Builder 200A is configured to generate at least once building blocks Video file which comprise instructions/hint for generating variation video using AI engine, which use the instruction/hints to create the variant building blocks Video files for customized data using Video Customization Server 600 and External resources of video data

The generated Variant building blocks Video files can be designated for streaming or Playable Video file.

FIG. 1 illustrates a block diagram depicting the key components and the operational environment of a system designed to generate variant video content from building blocks Video files, in accordance with some embodiments of the present invention.

The Video Model Builder 200A is a module configured to generate a building blocks Video files comprising instructions and hints for creating variations of the building blocks Video files using an Artificial Intelligence (AI) engine. The AI engine leverages these instructions/hints to generate customized variant building blocks Video files by incorporating data from the Video Customization Server and external video data resources.

The generated variant videos can be designated for streaming or packaged as playable video files, allowing for flexible distribution and consumption across various platforms and devices.

FIG. 1A is a block diagram showing components and environment of a system for generating variant video from story board model file, according to some embodiments of the invention;

FIG. 1A illustrates a block diagram depicting the key components and the operational environment of a system designed to generate variant video content from a model file, in accordance with some embodiments of the present invention.

The Video Model Builder story builder 200A is a module configured to generate a video model (or template) of multiple building blocks Video files comprising instructions and hints for creating variations of the building blocks Video files using an Artificial Intelligence (AI) engine. The AI engine leverages these instructions/hints to generate customized variant videos by incorporating data from the Video Customization Server and external video data resources.

The generated variant videos can be designated for streaming or packaged as playable video files, allowing for flexible distribution and consumption across various platforms and devices.

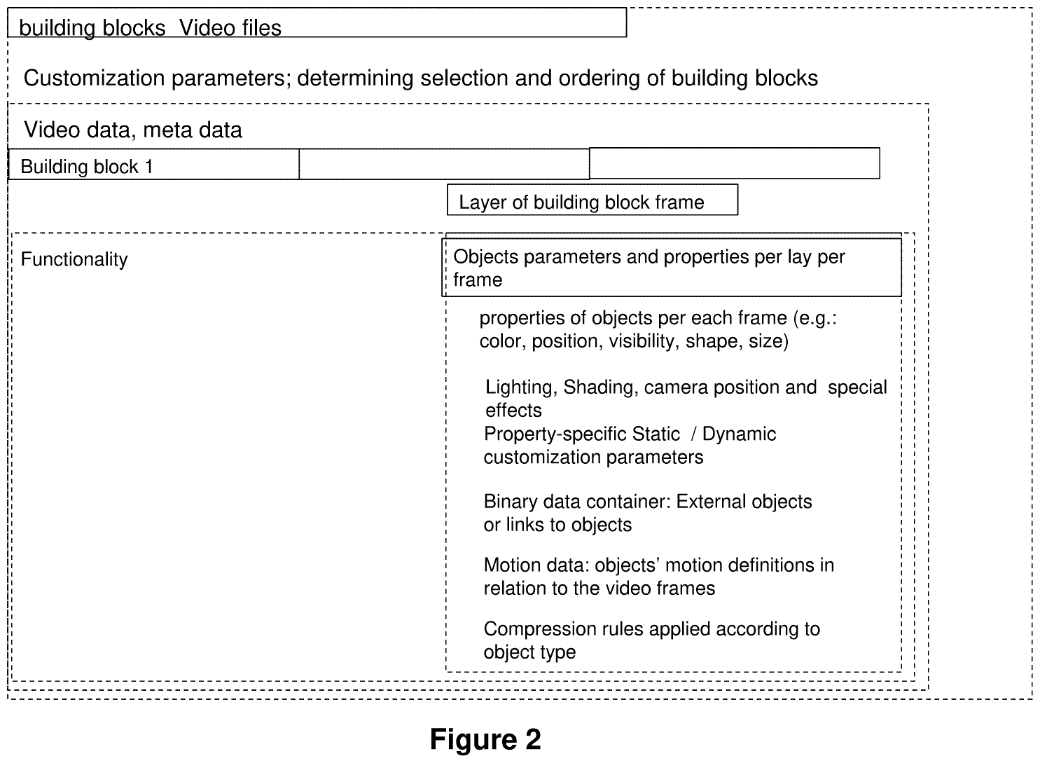

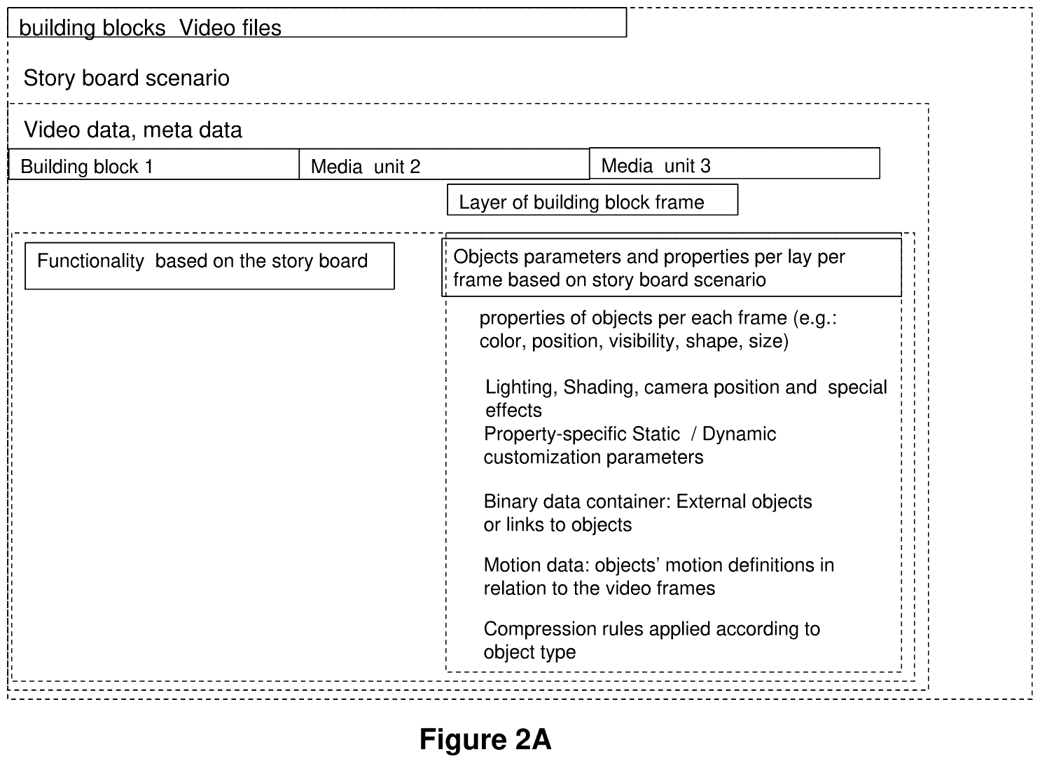

FIG. 2 is a diagram of building blocks Video files format, according to some embodiments of the invention;

The file format comprises Customization parameters; determining building blocks Video files parameters. Each building blocks is defined by functionally Elements and length.

For each building block frame layer are defined:

Objects parameters and properties per lay per frame

properties of objects per each frame (e.g.: color, position, visibility, shape, size);

properties of objects per each frame (e.g.: color, position, visibility, shape, size);

Property-specific Static/Dynamic customization parameters

Binary data container: External objects or links to objects

Motion data: objects' motion definitions in relation to the video frames

Compression rules applied according to object type

FIG. 2A is a diagram of building blocks Video files based on storyboard, according to some embodiments of the invention;

The file format comprises story board scenarios, which support Customization parameters; determining selection and ordering of building blocks. Each building blocks is defined by functionally Elements and length.

For each building block frame layer are defined:

Objects parameters and properties per lay per frame

properties of objects per each frame (e.g.: color, position, visibility, shape, size);

properties of objects per each frame (e.g.: color, position, visibility, shape, size)

Property-specific Static/Dynamic customization parameters

Binary data container: External objects or links to objects

Motion data: objects' motion definitions in relation to the video frames

Compression rules applied according to object type

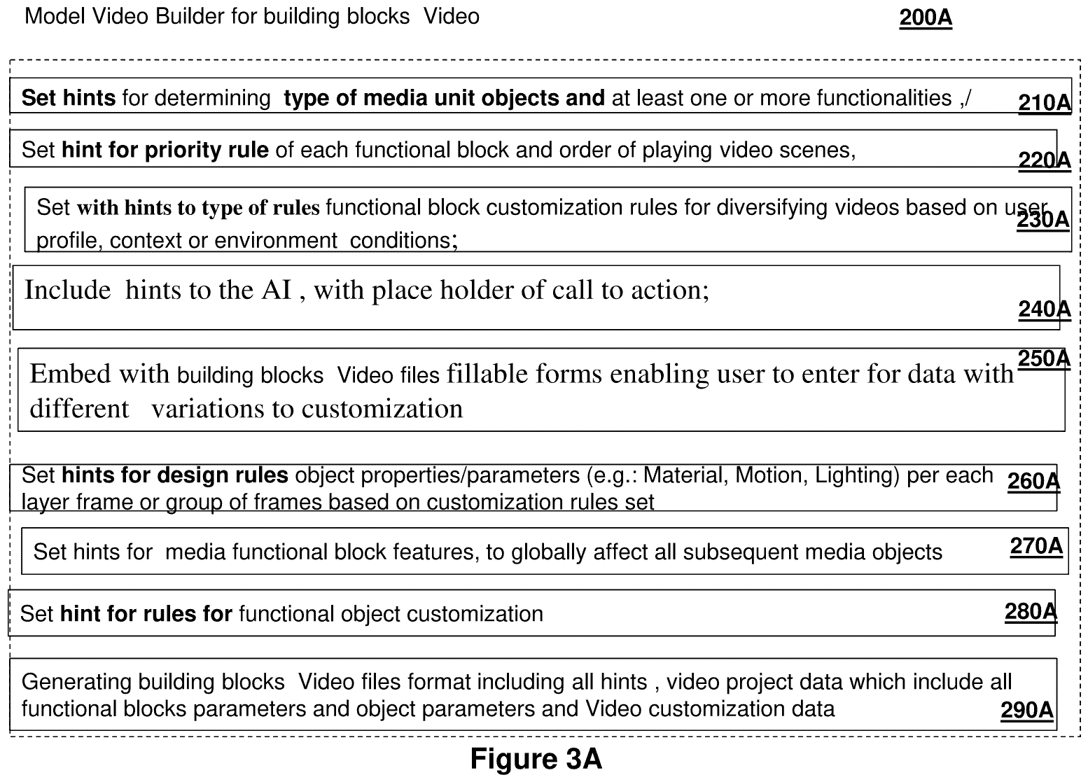

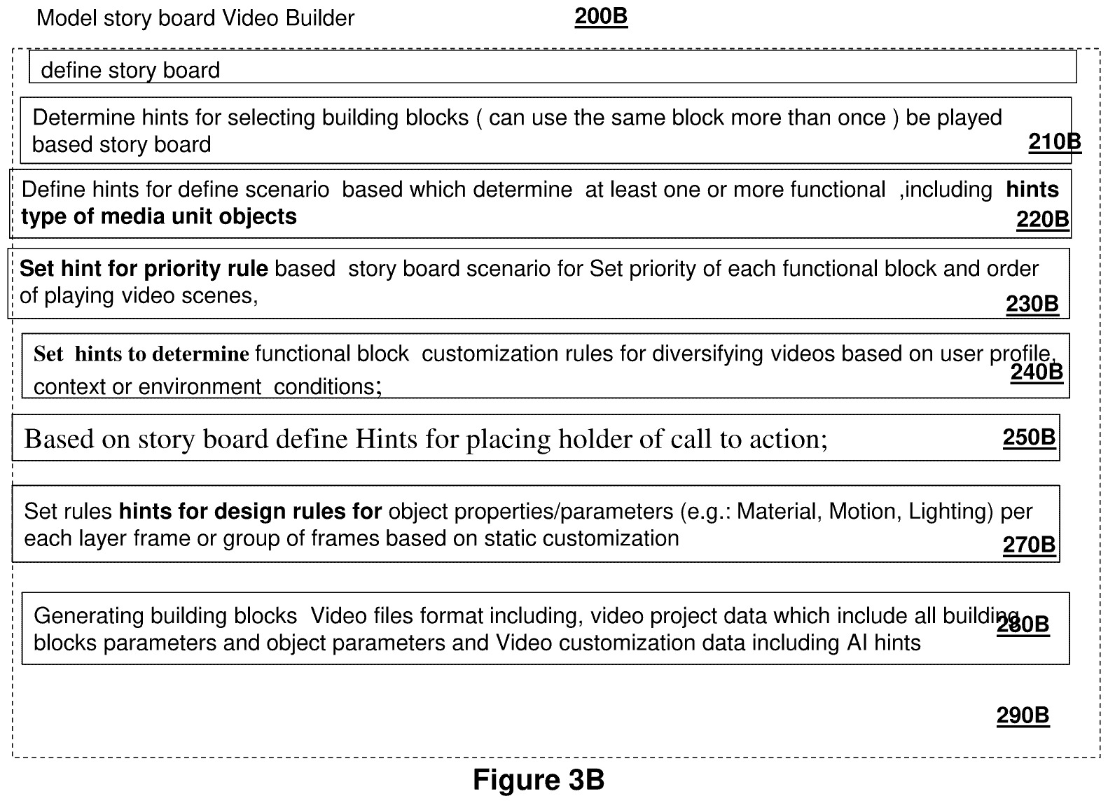

FIG. 3A is a flowchart diagram of Model Video Builder module, according to some embodiments of the invention;

Select at least one or more functional blocks,/hints type of building block objects 210A;

Set priority of each functional block and order of playing video scenes, hint for priority rule 210;

Set functional block customization rules for diversifying videos based on user profile, context or environment conditions with hints to type of rules 220B;

Include hints to the AI, with place holder of call-to-action 230B;

Embed with building blocks Video files invitation details in format logic of template for different variations to customization 240B;

Set object properties/parameters (e.g.: Material, Motion, Lighting) per each layer frame or group of frames based on customization rules set hints for design rules 2 of properties/parameters 50B;

Setting hints for media functional block features, to globally affect all subsequent media objects 260B;

Set hints for functional object customization 270B;

Generating building blocks Video files format including all hints, video project data which includes all functional blocks parameters and object parameters and Video customization data 280B.

FIG. 3A depicts a flowchart diagram of the Model Video Builder module, demonstrating its functionality in generating customized video content according to specific embodiments of the invention. This module systematically processes inputs and outputs to facilitate tailored video production.

The initial step involves selecting one or more functional blocks objects, designated as 210A. These blocks or units may include various types of media elements such as images, video clips, and audio tracks. Each selected item is potentially equipped with hints or instructions that guide their integration into the video building blocks Video files.

Next, the user sets the priority for each functional block, along with the order in which video scenes will play. This includes establishing a hint for the priority rule, identified as 210, which helps determine the sequencing of content based on its importance or relevance to the video's narrative structure.

The module then allows for the customization of functional blocks based on the user's profile, the context of the video, or environmental conditions. Customization rules are set with corresponding hints to the type of rules, denoted as 220B, ensuring that the video content adapts to the intended audience or usage scenario.

Hints are also included for the AI engine, marked as 230B, which involve placeholders for calls to action. These hints guide the AI in dynamically incorporating interactive elements or decision points within the video, enhancing viewer engagement.

The process includes embedding video building blocks Video files invitation details into the format logic of the template, coded as 240B. This step outlines how the video should be customized across different variations, ensuring that each version maintains coherence with the overall design and objectives.

Additionally, the user sets object properties or parameters for each layer frame or group of frames. These properties, which can include material attributes, motion dynamics, and lighting effects, are adjusted according to the established customization rules. Hints for these design rules are indicated as 250B.

Global features for media functional blocks are then set under 260B, affecting all subsequent media objects within the video. This step ensures uniformity and consistency in how media elements behave and interact throughout the video.

Further customization hints for functional objects are established under 270B, guiding the application of rules that modify how individual elements or scenes are presented based on predefined criteria.

Finally, the process culminates in the generation of a building blocks Video files format, labelled as 280B. This file includes all hints, video project data, parameters for all functional blocks, object parameters, and video customization data. The resulting file encapsulates all necessary information and instructions to produce a fully customized video, ready for use in various applications.

FIG. 3B is a block diagram storyboard Model Video Builder module, according to some embodiments of the invention;

define story board 205B;

Determine building blocks (can use the same block more than once) be played based story board 210B;

Use story board define scenario which determine at least one or more functional, including hints for type of building block 220B;

Set hint for priority rule Use story board scenario Set priority of each functional block and order of playing video scenes, 230B;

Set hints for rules to determine Set functional block customization rules for diversifying videos based on user profile, context or environment conditions 240B;

Based on story board define Hints for place holder of call-to-action 250B;

Set hints for design rules of object properties/parameters (e.g.: Material, Motion, Lighting) per each layer frame or group of frames based on static customization rules 260B;

Set hint for rules for AI building block object customization rules 270B;

Generating building blocks Video files format including, video project data which include all building blocks' parameters and object parameters and Video customization data including AI hints 280B;

FIG. 3B is a block diagram illustrating the storyboard Model Video Builder module, according to some embodiments of the invention. The storyboard Model Video Builder module is responsible for generating a model video file format that includes video project data and video customization data with AI hints.

Define the storyboard 205B, which serves as the foundation for the video generation process.

Determine the building blocks (individual video scenes or segments) that will be played based on the storyboard 210B. Note that the same building block can be used more than once in the video.

Use the storyboard to define the scenario, which determines one or more functional elements, including hints for the type of building block objects to be used 220B.

Based on the storyboard scenario, set the priority of each functional block and the order in which the video scenes will be played. Also, define hints for priority rules 230B that determine this ordering.

Set hints of functional block customization rules for diversifying the videos based on user profile, context, or environmental conditions, with hints provided for the type of rules to be applied 240B.

Based on the storyboard, define hints for placeholders of calls to action (e.g., interactive elements or links) should be included 250B.

Set object properties and parameters (e.g., material, motion, lighting) for each layer, frame, or group of frames based on static customization rules, with hints provided for the design rules to be followed 260B.

Set building block object customization rules, with hints provided for the rules that the AI should follow 270B.

Generate the model video file format, which includes the video project data (all data blocks parameters and object parameters) and the video customization data, including AI hints 280B.

Described bellow is flow showing a process carried out by Ai model for generating variant video, according to some embodiments of the invention; and

Determine building blocks (can use the same block more than once) be played and order of playing by applying AI models based on hint/instruction hint: [310] type of field, type pf content, limitation, relation between the object not the same

Determine each media object's configuration properties by applying AI models based on model hint [320]

Determine each building block customization rules by applying AI models based on model hint [330]

Update objects properties for each frame according to the extracted dynamic customization rules by applying AI models based on model's hint [340]

Determine relation between objects, by applying AI models based on hint [350]

fill out according to building blocks Video files hints

fill out forms based on knowledgebase or applying AI models based on model hint [360]

Generate frames layers according to binary media object data including updated properties for each frame and customization rules [365]

Apply video generating module to generate at least one video file or stream based on generated frames [370]

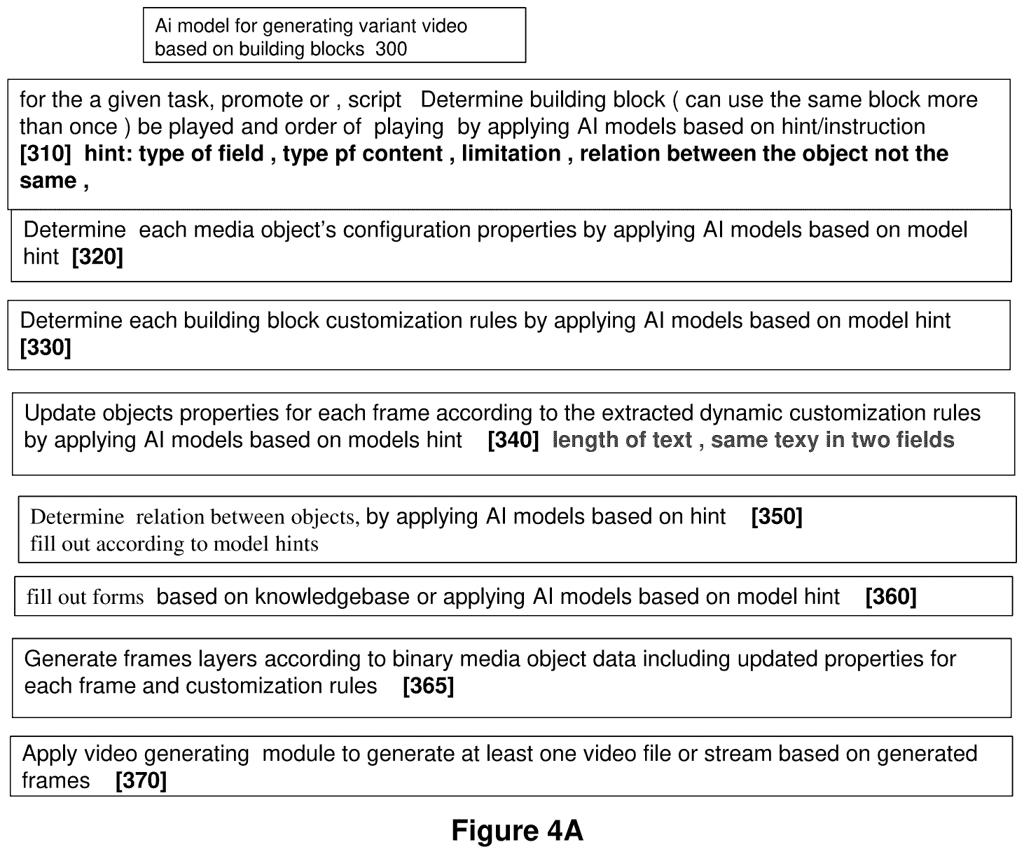

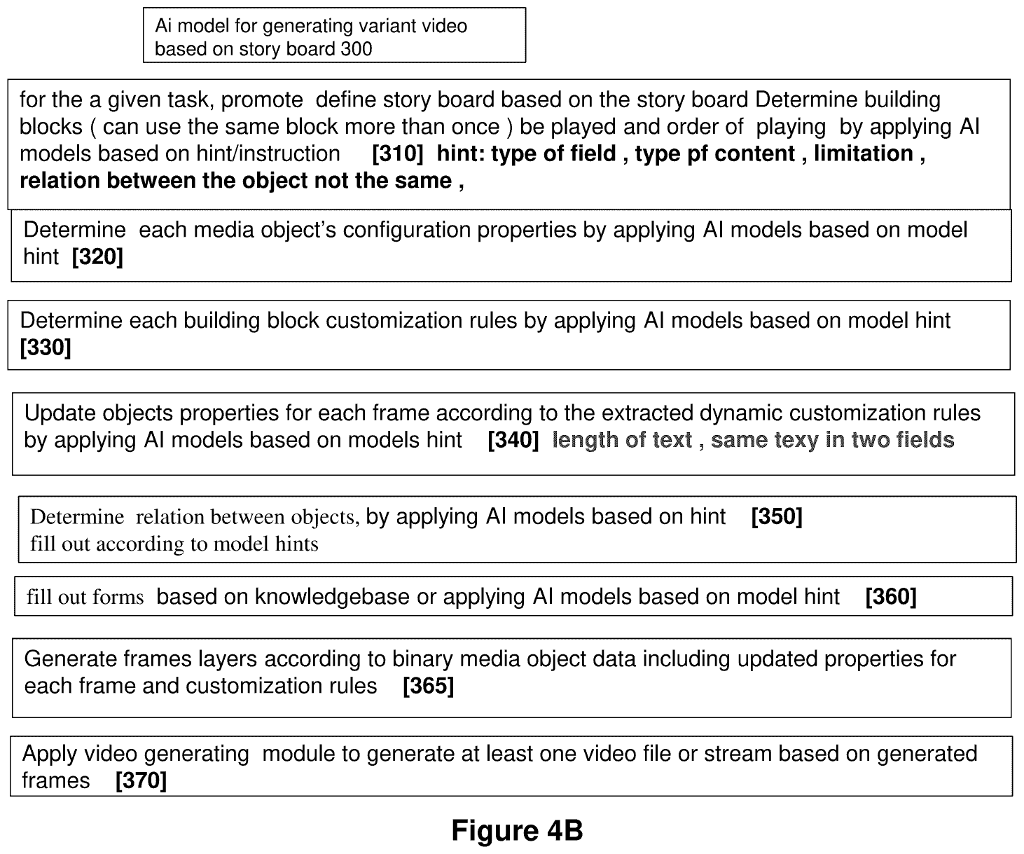

FIG. 4A is a flowchart diagram showing the process carried out by the AI model for generating variant videos, according to some embodiments of the invention.

For a given task defined, prompt text or, script:

Determine the building blocks (video scenes or segments) to be played and their order of playback by applying AI models based on the given prompt or script, the provided hints and instructions of building blocks [310]. The hints may include the type of content (e.g., product, service), the field or domain, limitations, and relationships between objects that should not be the same.

Determine the configuration properties for each media object by applying AI models based on the provided hints [320].

Determine the customization rules for each building block by applying AI models based on the provided 1 hints [330].

Update the object properties for each frame according to the extracted dynamic customization rules by applying AI models based on the provided hints [340].

Determine the relationships between objects by applying AI models based on the provided hints [350].

Fill out forms or placeholders of call to action according to the provided 1 hints, potentially by referring to a knowledge base or applying AI models based on the hints [360 ].

Generate the frame layers according to the binary media object data, including the updated properties for each frame and the customization rules [365].

Apply a video generation module to generate at least one video file or stream based on the generated frames [370].

FIG. 4A is a flowchart diagram illustrating a process carried out by an AI model for generating variant videos, in accordance with some embodiments of the present invention.

For a given task, such as a defined prompt, script, or text input:
The AI model determines a sequence of video building blocks (e.g., video scenes or segments) to be included in the video and the order of playback, based on the prompt or script and the associated hints and instructions embedded in the building blocks [310]. The hints may include information such as the type of content (e.g., product or service), the domain or subject area, usage constraints, and relational rules between objects (e.g., objects that should not be repeated or shown together).
The AI model determines the configuration properties of each media object by interpreting the provided model hints [320].
The AI model determines the customization rules applicable to each building block, based on the model hints [330].
The AI model updates the properties of each object for each frame, in accordance with the extracted dynamic customization rules derived from the model hints [340].
The AI model determines inter-object relationships based on the provided relational hints [350].
The AI model fills out forms or placeholder fields based on the model hints, optionally by accessing a knowledge base or other contextual resources [360].
Frame layers are generated based on binary media object data, including the updated object properties and applied customization rules [365].
A video generation module is invoked to generate at least one customized video file or stream based on the compiled frame layers [370].

FIG. 4B is a flowchart diagram showing the process carried out by the AI model for generating variant videos based on storyboard, according to some embodiments of the invention.

For a given task, prompt or script create a story board using designated AI model/Determine the building blocks (video scenes or segments) to be played and their order of playback by applying AI based on created storyboard, the provided hints of and instructions [310] of the building blocks. The hints may include the type of content (e.g., product, service), the field or domain, limitations, and relationships between objects that should not be the same.

Determine the configuration properties for each media object by applying AI models based on the provided model hints [320].

Determine the customization rules for each building block by applying AI models based on the provided model hints [330].

Update the object properties for each frame according to the extracted dynamic customization rules by applying AI models based on the provided model hints [340].

Determine the relationships between objects by applying AI models based on the provided hints [350].

Fill out forms or placeholders according to the provided hints, potentially by referring to a knowledge base or applying AI models based on the hints [360].

Generate the frame layers according to the binary media object data, including the updated properties for each frame and the customization rules [365].

Apply a video generation module to generate at least one video file or stream based on the generated frames [370].

The system of the present invention may include, according to certain embodiments of the invention, machine readable memory containing or otherwise storing a program of instructions which, when executed by the machine, implements some or all of the apparatus, methods, features and functionalities of the invention shown and described herein. Alternatively, or in addition, the apparatus of the present invention may include, according to certain embodiments of the invention, a program as above which may be written in any conventional programming language, and optionally a machine for executing the program such as but not limited to a general-purpose computer which may optionally be configured or activated in accordance with the teachings of the present invention. Any of the teachings incorporated herein may, wherever suitable, operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer-or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

1. A computer-implemented method for generating a variant building blocks Video files, implemented by one or more processors operatively coupled to a non-transitory computer readable storage device, on which are stored modules of instruction code that when executed cause the one or more processors to perform said method comprising the steps of:
generating, by a video model builder module, at least one building blocks, each building block defines by hints and instructions configured to define:
functional elements and length;
object parameters and properties per frame layer, including at least one of: color, position, visibility, shape, and size;
customization parameters comprising instructions and hints for video variation;
placeholders for call-to-action elements;
binary media object data or links to external media resources; and
processing, by an artificial intelligence (AI) engine, the instructions and hints of the building blocks to:
determine a sequence and selection of building blocks based on user prompt, profile data, contextual information, and environmental conditions;
update object properties dynamically per frame according to customization rules;
define inter-object relationships and generate frame layers accordingly;
generating, based on the processed frame layers, at least one customized variant video file or stream.

2. The method of claim 1 wherein the AI model fills out form's fields based on the hints and instructions, optionally by accessing a knowledge base or other contextual resources.

3. The method of claim 1 wherein a given storyboard defines the scenario, which determines one or more functional elements, including hints for the type of building block objects to be used.

4. The method of claim 1 wherein based on the storyboard are defined hints for placeholders of calls to actions.

5. The method of claim 1 wherein each building block customization rules are determined by applying AI models based on the hint and instructions.

6. The method of claim 1 wherein the generation of the frame layers is according to the binary media object data, including the updated properties for each frame and the customization rules.

7. A system for generating variant video content implemented by one or more processors operatively coupled to a non-transitory computer readable storage device, which comprise the module of:
a video model builder configured to create a at least one building blocks, each building block defines by hints and instructions for comprising a plurality of building blocks, object properties, and AI customization hints;
a customization server configured to retrieve contextual data and user profile information;
an AI engine configured to:
interpret and analyse user prompt, the customization hints;
determine a sequence and selection of building blocks based on user prompt, profile data, contextual information, and environmental conditions
assign object properties and scene ordering;
determine relationships between objects and generate customization rules;
a video generation module configured to assemble video frame layers based on updated properties and generate at least one playable video or stream

8. The system of claim 7 wherein the AI model fills out forms or placeholder fields based on the building blocks Video files hints, optionally by accessing a knowledge base or other contextual resources.

9. The system of claim 7 wherein a given storyboard defines the scenario, which determines one or more functional elements, including hints for the type of building block objects to be used.

10. The system of claim 7 wherein based on the storyboard are defined hints for placeholders of calls to actions.

11. The system of claim 7 wherein each building block customization rules are determined by applying AI models based on building blocks Video files hint and instructions.

12. A method for creating variation video; based on the video building blocks Video files implemented by one or more processors operatively coupled to a non-transitory computer readable storage device, on which are stored modules of instruction code that when executed cause the one or more processors to perform said method comprising the steps of:
Generating video blocks comprising instructions and hints for creating variations of the building blocks Video files I using an Artificial Intelligence (AI) engine
Creating changing the content and format/structure of the video blocks by AI model based on hints/instructions of the video blocks based on given video instructions based on given prompt.
